(19) United States
(12) Patent Application Publication
(10) Pub. No.: US 2006/0290260 A1
(43) Pub. Date: Dec. 28, 2006

(54) Field emission display having carbon nanotube emitter and method of manufacturing the same

(76) Inventors: Jun-Hee Choi, Suwon-si (KR); Andrei Zoulkarneev, Suwon-si (KR); Ho-Suk Kang, Seoul (KR); Moon-Jin Shin, Yongin-si (KR)

Correspondence Address: Robert E. Bushnell, Suite 300, 1522 K Street, N.W., Washington, DC, 20005, US

(21) Appl. No.: 11/178,611

(22) Filed: Jul. 12, 2005

(30) Foreign Application Priority Data
Jul. 26, 2004 (KR) 2004-0058348

(51) Int. Cl. H01J 63/04

(52) U.S. Cl. 313/495; 313/497

(57) ABSTRACT

A field emission display (FED) using carbon nanotube emitters and a method of manufacturing the same. A gate stack that surrounds the CNT emitter includes a mask layer that covers an emitter electrode adjacent to the CNT emitter, and a gate insulating film, a gate electrode, a focus gate insulating film (SiO_{X}, X<2), and a focus gate electrode formed on the mask layer. The height of the mask layer is greater than that of the CNT emitter. The focus gate insulating film has a thickness 2 μm or more, and preferably 3˜15 μm. In a process of forming the focus gate insulating film and/or the gate insulating film, a flow rate of silane is maintained at 50˜700 sccm and a flow rate of nitric acid (N₂O) is maintained at 700˜4,500 sccm.

### CLAIM OF PRIORITY

This application makes reference to, incorporates the same herein, and claims all benefits accruing under 35 U.S.C. §119 from an application for FIELD EMISSION DISPLAY HAVING CARBON NANOTUBE EMITTER AND METHOD OF MANUFACTURING THE SAME earlier filed in the Korean Intellectual Property Office on 26 Jul. 2004 and there duly assigned Serial No. 10-2004-0058348.

### BACKGROUND OF THE INVENTION

1. Field of the Invention

A flat display panel and a method of manufacturing the same, and more particularly, to a field emission display having a carbon nanotube emitter and a method of manufacturing the same.

2. Description of the Related Art

It is readily predicted that cathode ray tubes will be superceded by flat display panels such as liquid displays, light emitting diodes, plasma display panels, and field emission displays (FED). Among these, the FED, which has advantages of high resolution, high efficiency, and low power consumption, receives a lot of attention as a display device for the next generation.

A core technology of the FED is a processing technique of an emitter tip used to emit electrons and a stability of the processing technique. In a conventional FED, a silicon tip or a molybdenum tip is used as the emitter tip. However, both silicon tips and molybdenum tips have short lifetimes, low stability, and low electron emission efficiency.

Turning now to FIG. 1, FIG. 1 is an SEM image illustrating a defect in an earlier FED. In FIG. 1, reference numerals 4, 6, and 8 respectively represent a gate electrode, a silicon oxide film, and a focus gate electrode while reference numeral 10 is a crack. The FED of FIG. 1 has poor step coverage at a step portion of the silicon oxide (SiO₂) film 6 formed between the focus gate electrode 8 and a gate electrode 4. This poor step coverage can result in electrical defects such as the crack 10 illustrated in FIG. 1 that causes insulating breakage at the step portion. Such defect could generate a leakage current between the two electrodes, thus generating joule heat at the step portion.

The above problem associated with the silicon oxide film (SiO₂) can be solved to some degree by increasing the thickness of this silicon oxide film. However, it is not easy to obtain a desirable thickness because delamination occurs when the thickness of the silicon oxide film is increased to over 2 μm.

In order to solve this delamination problem, several FEDs having a variety of structures have been developed. In earlier FEDs, an FED having an imbedded focusing structure and an FED having a metal mesh structure are widely used. In the former case, a possibility of crack formation between a focus gate electrode and a gate electrode used to extract electrons is low, but an outgassing process for venting gas generated by polyimide is required because the focus gate electrode is formed on polyimide. Regarding the latter case, focusing an electron beam can be improved by placing a metal mesh around the tip. However, processing and bonding the metal mesh are difficult, and in particular, an electron beam may be shifted due to misalignment of the metal mesh. What is therefore needed is an FED design and a method of making the FED that overcomes the above problems, resulting in an oxide layer that does not crack or peel off, does not outgas, is easy to make, and does not result in other adverse side effects.

### SUMMARY OF THE INVENTION

It is therefore an object of the present invention to provide an improved design for an FED.

It is also an object of the present invention to provide a design for an FED that does not result in delamination of layers or cracks in layers, without causing other adverse effects.

It is also an object to provide an improved emitter for an FED.

It is further an object of the present invention to provide a method of making an FED that does not result in a structure that delaminates, cracks, or outgases.

It is still an object of the present invention to provide a method of making an FED that is simple, inexpensive, and easy to manufacture.

It is also an object of the present invention to provide a design for an FED and a method of making that does not result in leakage current between the gate and focus electrodes.

It is yet an object of the present invention to provide an FED that provides superior ability to focus electrodes.

It is also an object of the present invention to provide an FED that has superior image quality.

These and other objects can be achieved by a CNT (carbon nanotube) FED that has a substrate, a transparent electrode formed on the substrate, a CNT emitter formed on the transparent electrode, a gate stack that extracts an electron beam from the CNT emitter and focuses the extracted electron beam to a predetermined target, the gate stack being formed on peripheral area of the CNT emitter, a front panel that is formed above the gate stack and on which an information is displayed and a fluorescent film formed on a back surface of the front panel, the gate stack having a mask layer that covers the transparent electrode around the CNT emitter and has a height greater than the CNT emitter.

The mask layer may be an amorphous silicon layer doped with conductive impurities. A height of the mask layer may be greater than a height of the CNT emitter by 0.1-4 μm. When the mask layer is made of some other material, a height difference between the mask layer and the CNT emitter may be different from the above range. The mask layer may have a specific resistance of 10²-10⁹ Ωcm.

The gate stack may also includes a gate insulating film, a gate electrode, a focus gate insulating film, and a focus gate electrode sequentially stacked on the mask layer. According to specific embodiments of the present invention, the focus gate insulating film may be formed of a second silicon oxide (SiOₓ) film where x<2 and is 2 microns thick, preferably 3 to 15 microns thick and more preferably between 6 and 15 microns thick. The gate insulating film is a first silicon oxide film SiOₓ film where x<2 and is between 1 and 5 microns thick. Alternatively, the gate insulating film may instead be SiO₂. A plurality of CNT emitters may be formed in one focus gate electrode.

According to another aspect of the present invention, there is provided a method of manufacturing a CNT FED having the above-described structure, the method including forming the gate stack including a mask layer formed on the transparent electrode around the CNT emitter, and after forming the gate stack, forming the CNT emitter having a height smaller than a height of the mask layer.

The forming the gate stack may include forming a mask layer with a through hole that exposes a portion of the transparent electrode, forming a gate insulating film that fills the through hole on the mask layer, forming a gate electrode on the gate insulating film around the through hole, forming a focus gate insulating film (SiOₓ, x<2) on the gate electrode and the gate insulating film, forming a focus gate electrode on the focus gate insulating film located around the through hole and removing the gate insulating film and the focus gate insulating film located within the gate electrode.

The gate insulating film may be formed of a silicon oxide (SiOₓ) film where x<2 and is 1 to 5 microns thick. Alternatively, the gate insulating film may be a SiO₂ film. The focus gate insulating film is formed to a thickness of 2 μm or greater, preferably, 3˜15 μm, more preferably, 6˜15 μm. In the forming the second silicon oxide film for the focus gate insulating film, a flow rate of silane (SiH₄) may be maintained at 50˜700 sccm, a flow rate of nitric acid (N₂O) may be maintained at 700˜4,500 sccm, a process pressure may be maintained at 600˜1,200 mTorr, a temperature of the substrate may be maintained at 250˜450° C., and an RF power may be maintained at 100˜300 W. The first silicon oxide film for the gate insulating film can be formed under the above-described conditions.

A hole may be etched through the focus gate insulating film be removed by coating a photosensitive film on the focus gate insulating film and on the gate insulating film formed within the focus gate electrode, exposing the photosensitive film formed above the through hole, removing the exposed portion of the photosensitive film, wet etching the focus gate insulating film using the photosensitive film from which the exposed portion is removed as an etch mask, and removing the photosensitive film. All these processes involved in the removing the focus gate insulating film can be repeatedly performed.

The photosensitive film may be exposed to ultra violet rays from below the substrate during the exposing the photosensitive film. The exposing the photosensitive film may involve arranging a mask having a transmission window to a region corresponding to the through hole and over the photosensitive film and radiating light toward the mask from above the mask. All the processes involved in perforating the focus gate insulating film may also be used in the removal of the gate insulating film. In this case, all the processes can be repeatedly performed. The focus gate electrode may be formed such that a plurality of through holes are formed in the focus gate electrode.

The forming the CNT emitter having a height less than the mask layer may involve forming a CNT emitter having a height greater than the mask layer and reducing the height of the CNT emitter by surface treatment so that the height of the CNT emitter is lower than that of the mask layer. The height of the CNT emitter can be reduced until a height difference between the mask layer and the CNT emitter reaches a range of 0.1-4 μm. The mask layer may be made of a material layer having a specific resistance of 10²-10⁹ Ωcm.

The CNT FED according to the present invention includes a focus gate insulating film by which an excellent step coverage is obtained between the focus gate electrode and the gate electrode and which has an enough thickness to minimize stresses between the focus gate electrode and the gate electrode. Therefore, defects such as cracks are not generated in the focus gate insulating film, thus reducing leakage current between the focus gate electrode and the gate electrode. Since the focus gate insulating film has a sufficiently large thickness, the focus gate electrode and the gate electrode are separated away from each other by a distance corresponding to the large thickness. Therefore, an insulation breakage between the two electrodes by impurities adhering to the focus gate insulating film can be avoided. Also, the manufacturing process can be simplified because the photosensitive film is patterned by self-alignment instead of using an additional mask, thus reducing manufacturing costs.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a SEM image illustrating a defect in a conventional FED;

FIG. 2 is a cross-sectional view of an FED that includes a CNT emitter according to an exemplary embodiment of the present invention;

FIGS. 3 through 11 are cross-sectional views showing processes for stacking and etching an oxide film applied for forming the gate insulating film and the focus gate insulating film which are included in a gate stack of an FED depicted in FIG. 2;

FIG. 12 is a SEM image of a resultant product on which a photosensitive film remains right after first wet etching for an oxide film during the oxide film stacking and etching processes depicted in FIGS. 3 through 11;

FIG. 13 is a SEM image for a resultant product from which a photosensitive film depicted in FIG. 12 is removed;

FIG. 14 is a SEM image of a resultant product on which a photosensitive film remains right after second wet etching for an oxide film during the oxide film stacking and etching process depicted in FIGS. 3 through 11;

FIG. 15 is a SEM image for a resultant product from which a photosensitive film depicted in FIG. 14 is removed;

FIG. 16 is a SEM image of a resultant product from which a photosensitive film is removed after completing four times of wet etching for an oxide film during the oxide film stacking and etching process depicted in FIGS. 3 through 11;

FIG. 17 is a cross-sectional view illustrating a process of exposing a photosensitive film from the top side using a separate mask which differs from the back side exposing method depicted in FIGS. 3 through 11;

FIGS. 18 through 28 are cross-sectional views illustrating steps for forming a gate stack and a carbon nanotube emitter in the method of manufacturing an FED depicted in FIG. 2;

FIG. 29 is a graph illustrating a deposition rate of a focus gate insulating film of a gate stack of an FED depicted in FIG. 2 with respect to flow rate of silane (SiH₄).

FIG. 30 is a graph illustrating a stress of the focus gate insulating film of the gate stack of the FED depicted in FIG. 2 with respect to flow rate of nitric acid (N₂O).

FIG. 31 is a graph illustrating stress of the focus gate insulating film of the gate stack of the FED depicted in FIG. 2 with respect to a temperature of a substrate and flow rate of nitric acid;

FIG. 32 is a graph illustrating an etching rate of the focus gate insulating film of the gate stack of the FED depicted in FIG. 2 with respect to flow rate of silane (SiH₄);

FIG. 33 is a graph illustrates leakage current with respect to a thickness of the focus gate insulating film of the gate stack of the FED depicted in FIG. 2; and

FIG. 34 is SEM images showing a stack of a gate electrode, a focus gate insulating film, and a focus gate electrode formed according to the method of manufacturing the FED depicted in FIGS. 18 through 28.

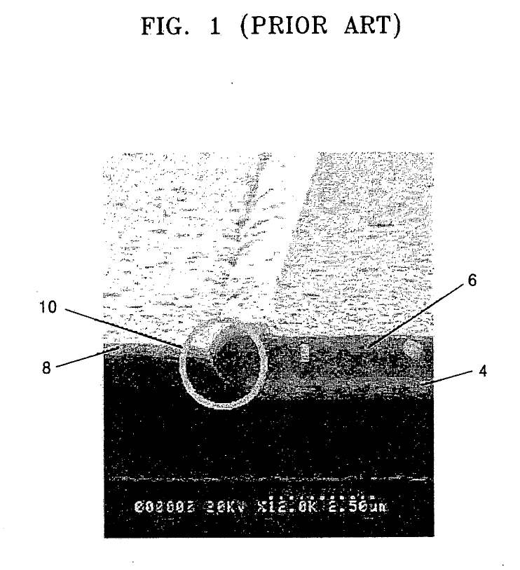

### DETAILED DESCRIPTION OF THE INVENTION

The present invention will now be described more fully with reference to the accompanying drawings in which exemplary embodiments of the invention are shown. In the drawings, the thicknesses of layers and regions are exaggerated for clarity. A carbon nanotube field emission display (CNT FED) according to the present invention will be described.

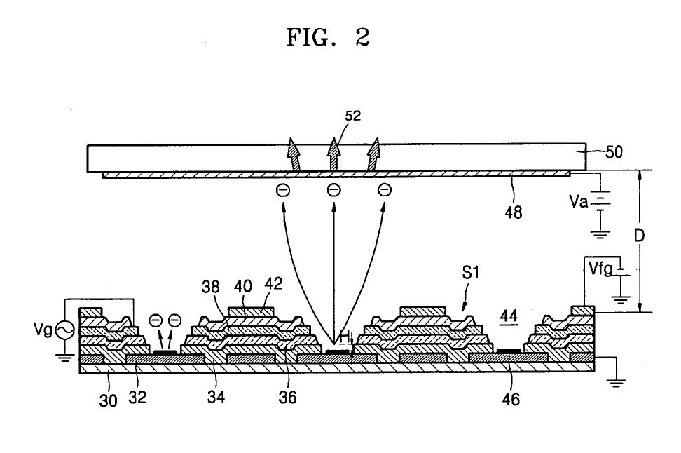

Turning to FIG. 2, FIG. 2 is a cross-sectional view of an FED that includes a CNT emitter according to an exemplary embodiment of the present invention. Referring to FIG. 2, transparent electrodes 32 are formed on a glass substrate 30. The transparent electrodes 32 may be indium tin oxide (ITO) electrodes and may serve as emitter electrodes. Gate stacks S1 that cover a portion of the transparent electrodes 32 are formed on the glass substrate 30. There are contact holes 44 that expose portions of the transparent electrodes 32 between the gate stacks S1. CNT emitters 46 that emit electrons are formed on a portion of the transparent electrode 32 exposed through the contact holes 44. The CNT emitters 46 do not contact the gate stack S1.

Each gate stack S1 includes a first mask layer 34 that covers a portion of the transparent electrodes 32 serves as a photolithography mask when back-exposed during the manufacturing process. The first mask layer 34 is spaced away from the CNT emitters 46. The first mask layer 34 may be an amorphous silicon layer doped with predetermined impurities, for example, phosphorus (P). There is a step, i.e., height difference (H), between the first mask layer 34 and the CNT emitters 46. A top surface of the first mask layer 34 is higher than the top of the CNT emitters 46. The height difference (H) may be, for example, in a range of 0.1-4 μm. The height difference (H) between the first mask layer 34 and the CNT emitters 46 may vary depending on the material used as the first mask layer 34. The first mask layer 34 has a specific resistance of 10²-10⁹ Ωcm, preferably, less than 10³ Ωcm. A gate insulating film 36, a gate electrode 38, a focus gate insulating film 40, and a focus gate electrode 42 are sequentially formed on the first mask layer 34 and have sequentially narrowing widths. Accordingly, a side surface of the gate stack S1 is sloped with steps.

In a manufacturing process for forming the CNT FED depicted in FIG. 2, which will be describe later, a number of components that constitute the gate stack S1 are patterned by a back-exposing method using ultra violet rays. Therefore, the first mask layer 34 is preferably transparent to visible light, but opaque to ultra violet rays and can be an amorphous silicon layer. The gate insulating film 36 is preferably a first silicon oxide (SiOₓ) film where x is less than 2 (x<2). This gate insulating film 36 is preferably formed to have a thickness of 1 to 5 microns. Also, the gate insulating film 36 could be a SiO₂ film. The gate electrode 38 is a first chrome electrode with a thickness of about 0.25 μm or a conductive electrode with a thickness other than 0.25 μm. The focus gate insulating film 40 that insulates the gate electrode 38 from the focus gate electrode 42 is a second silicon oxide (SiOₓ) film having a thickness of 2 μm or more, and preferably 3˜15 μm with x less than 2 (x<2). The focus gate insulating film 40 can also be an insulating film having equivalent or similar physical characteristics to the first silicon oxide film. The focus gate electrode 42 is formed symmetrically about the CNT emitter 46 and is a second chrome electrode having a predetermined thickness. The focus gate electrode 42 can be made of other materials besides chrome, and can also have a different thickness from the second chrome electrode.

The gate electrode 38 is used for extracting an electron beam from the CNT emitter 46. Accordingly, a predetermined alternating gate voltage Vg, for example, +80 V may be applied to the gate electrode 38.

The focus gate electrode 42 serves as a collector for collecting electrons emitted from the CNT emitter 46 so that the electrons can reach a fluorescent film 48 located above the CNT emitter 46. For this purpose, a focus gate voltage Vfg that has the same polarity as the electron beam and has a lower absolute value than the alternating gate voltage Vg may be applied to the focus gate electrode 42. For example, a focus gate voltage Vfg of −10 V can be applied to the focus gate electrode 42.

Referring to FIG. 2, a front panel 50 is positioned above the focus gate electrode 42 of the gate stack S1. The front panel 50 is spaced away by a predetermined distance D above the focus gate electrode 42 of the gate stack S1. A variety of information is displayed on the front panel 50. A fluorescent film 48 is attached to a bottom surface of the front panel 50 on a side of the front panel 50 that faces the gate stack S1 and a direct current voltage Va is applied to the fluorescent film 48. A fluorescent substance that emits red R, green G, and blue B when excited by the electron beam is evenly distributed on the fluorescent film 48. In FIG. 2, spacers separating the front panel 50 from the gate stack S1 and black matrix are not shown for convenience.

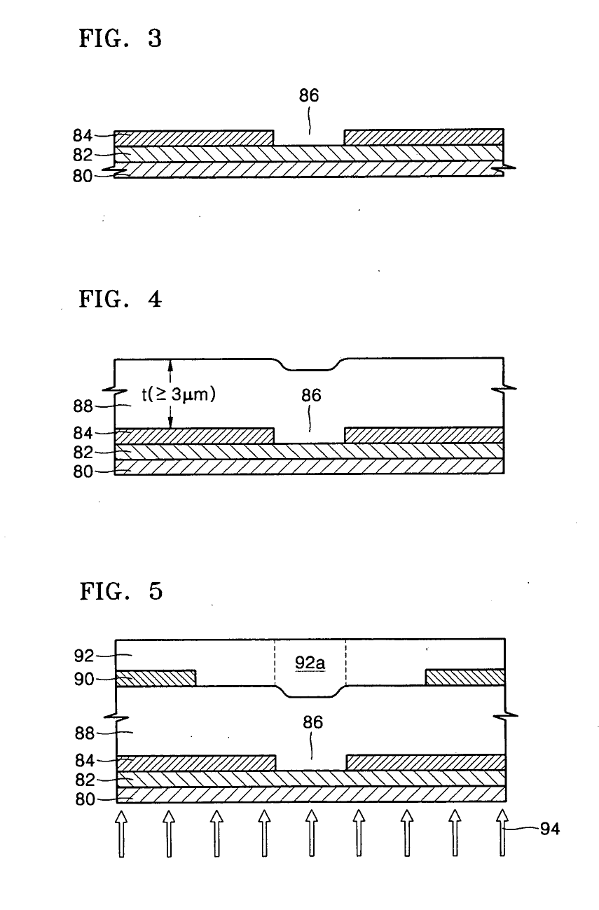

A method of manufacturing the CNT FED, particularly for forming the gate stack and holes in each of the gate insulating film 36 and the focus gate insulating film 40 according to an exemplary embodiment of the present invention will now be described in conjunction with FIGS. 3 through 11. Referring to FIG. 3, a first electrode 82 is formed on a substrate 80. The substrate 80 may correspond to the glass substrate 30 of the CNT FED (hereinafter, CNT FED of the present invention) illustrated in FIG. 2. The first electrode 82, which is an ITO electrode, corresponds to the transparent electrode 32 of the CNT FED of the present invention. A second mask layer 84 is formed on the first electrode 82. A through hole 86 that exposes the first electrode 82 is formed in the second mask layer 84. The second mask layer 84 is preferably formed of a material that it is transparent to visible light, but opaque to ultra violet light, such as an amorphous silicon layer. The second mask layer 84 may correspond to the first mask layer 34 of the CNT FED of the present invention described above.

Referring to FIG. 4, an insulating film 88 that fills the through hole 86 is formed on the second mask layer 84 to a predetermined thickness t. The insulating film 88 is preferably formed of a silicon film (SiOₓ) (x<2) having a higher silicon content than in a conventional silicon film (SiO₂). The insulating film 88 can be formed to a thickness of 2 μm or more, preferably 3˜15 μm, and more preferably 6˜15 μm. The insulating film 88 can be formed to a different thickness from the silicon oxide film (SiOₓ) using a plasma enhanced chemical vapor deposition (PECVD) method using RF (radio frequency). However, the method of forming the insulating film 88 may differ according to the thickness to be formed. For example, when forming the insulating film 88 at a lower end of the thickness range as suggested above, the insulating film 88 can be formed by a sputtering method. On the other hand, when forming the insulating film 88 at a thicker or upper end of the thickness range as suggested above, the insulating film 88 can be formed by an electroplating method or a thermal evaporation method.

When forming as the insulating film 88 with a silicon oxide film (SiOₓ) using the PECVD method, the process conditions are as follows. During growth of insulating film 88, the substrate 80 is maintained in a temperature range of 250˜450° C., preferably 340° C., and the RF power is maintained in a range of 100˜300 W, and preferably 160 W. Pressure in the chamber is maintained in a range of 600˜1,200 mTorr, and preferably 900 mTorr. The flow rate of silane (SiH4) in source gases is preferably controlled to maintain a deposition rate of 400 nm/min or more. For example, the flow rate of silane (SiH₄) is maintained at a much higher level than a conventional flow rate (15 sccm) for forming a silicon oxide film (SiO₂), that is, about 50˜700 sccm, and preferably 300 sccm. Also, the flow rate of nitric acid (N₂O) in the source gases is maintained at about 700˜4,500 sccm, and preferably 1,000˜3,000 sccm.

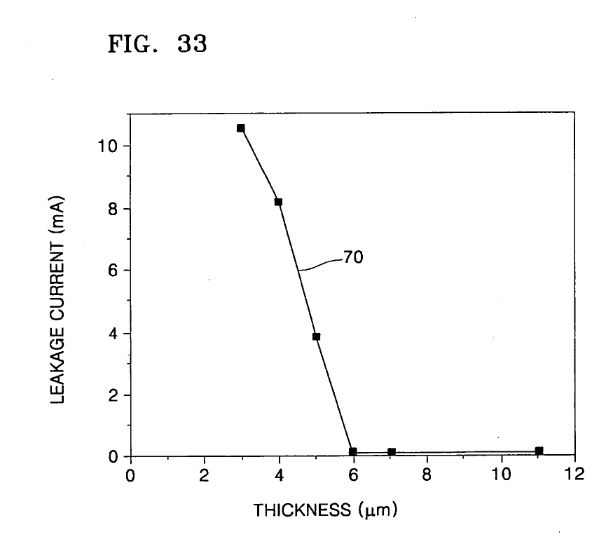

The same flow rate of silane (SiH₄) can be applied for the etching process of silicon oxide film (SiOₓ) using the PECVD method. As shown in graph 68 in FIG. 32, the etching rate of the silicon oxide film (SiOₓ) is much greater than in a conventional case C1 when the same flow rate range of silane as suggested above. The flow rate of silane in the etching of the silicon oxide is preferably maintained so that the etching rate of the silicon oxide is 100 nm/min or more.

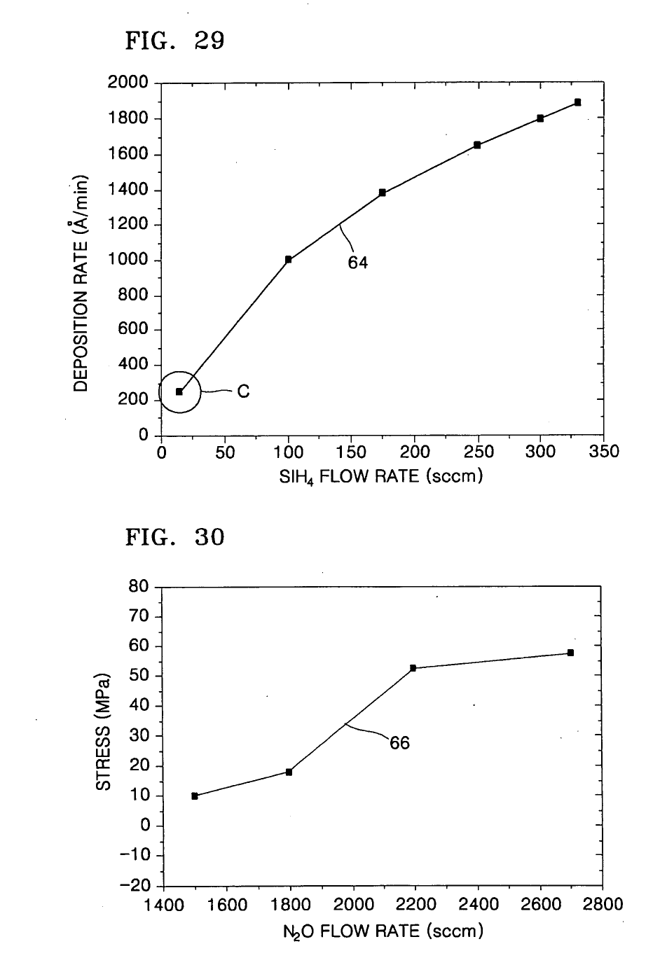

When forming the silicon oxide film (SiOₓ) under the process conditions as described above, the silicon oxide film can be formed to a thickness as mentioned above. Therefore, the step coverage is improved over that of the conventional art. As shown in graph 64 in FIG. 29, the deposition rate (in Å/min) is much greater than in the conventional deposition rate when the silane flow rate is increased.

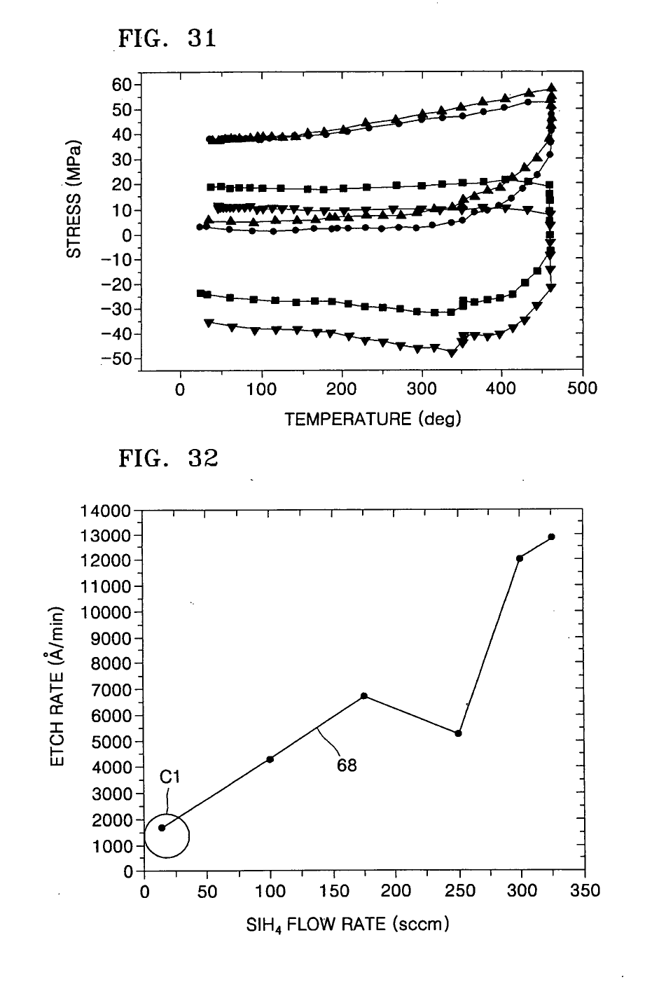

Also, as illustrated in graph 66 in FIG. 30, when controlling the flow rate of nitric acid, stress of the silicon oxide film (SiOₓ) is lowered below 100 Mpa. Furthermore, as shown in FIG. 31, when the flow rate of the nitric acid remains constant and the temperature of the substrate varies within the above-described range, stress of the silicon oxide film (SiOₓ) is less than 100 Mpa.

The low stress of the silicon oxide film (SiOₓ) means that the density of the silicon oxide film (SiOₓ) is lower than that of the conventional silicon oxide film. This means that the silicon oxide film (SiOₓ) is similar to porous materials.

In FIG. 31, the positive (+) stress values represent compressive stresses, while, the negative value (−) stress values represent a tensile stresses. Reference symbols “▴”, “●”, “▪”, and “▾” represent cases when the flow rate of nitric acid is 2,700 sccm, 2,200 sccm, 1,800 sccm, and 1,500 sccm, respectively.

When forming the silicon oxide film (SiOₓ) under the given process conditions, a silicon oxide film (SiOₓ) that has a higher in silicon concentration and much lower stress than a conventional silicon oxide film can be formed. Therefore, the possibility that defects such as cracks will be present in the insulating film 88 which is formed of the silicon oxide film (SiOₓ), and particularly in the step region, is lower than conventional silicon oxide films. Accordingly, when the insulating film 88 is formed according to the above process, a possibility of leakage current between the second electrode 90 which will be formed on the insulating film 88 and the first electrode 82 is very low.

A different insulating film (correspondence to the gate insulating film 36 of the present FED) that covers the second mask layer 84 and a different electrode (correspondence to the gate electrode 38 of the present FED) can be sequentially formed between the second mask layer 84 and the insulating film 88. In this case, when the insulating film 88 is formed under the above process conditions, a leakage current between an electrode which will be formed on the insulating film and other electrodes can be reduced due to the characteristics of the insulating film 88 described above.

Referring to FIG. 5, a second electrode 90 is formed on the insulating film 88. The second electrode 90 can be a chrome electrode but can also be made of another material. The second electrode 90 may correspond to the focus gate electrode 42 or gate electrode 38 included in the gate stack S1 of the FED of FIG. 2. A first photosensitive film 92 is formed on the second electrode 90 and on the insulating film 88. First photosensitive film 92 is preferably made of a positive photoresist. After forming the first photosensitive film 92, ultra violet rays 94 are radiated onto a lower surface of the substrate 80 to thus back expose portions of the first photosensitive film 92. In such a back exposure, second mask layer 84 serves as a photo mask. At this time, regions besides those not exposed by the through hole 86 in the second mask layer 84 are not exposed to the ultra violet rays 94 because of the second mask layer 84. The ultra violet rays 94 penetrate through the through hole 86 by which an exposure region 92a of the first photosensitive film 92 is exposed.

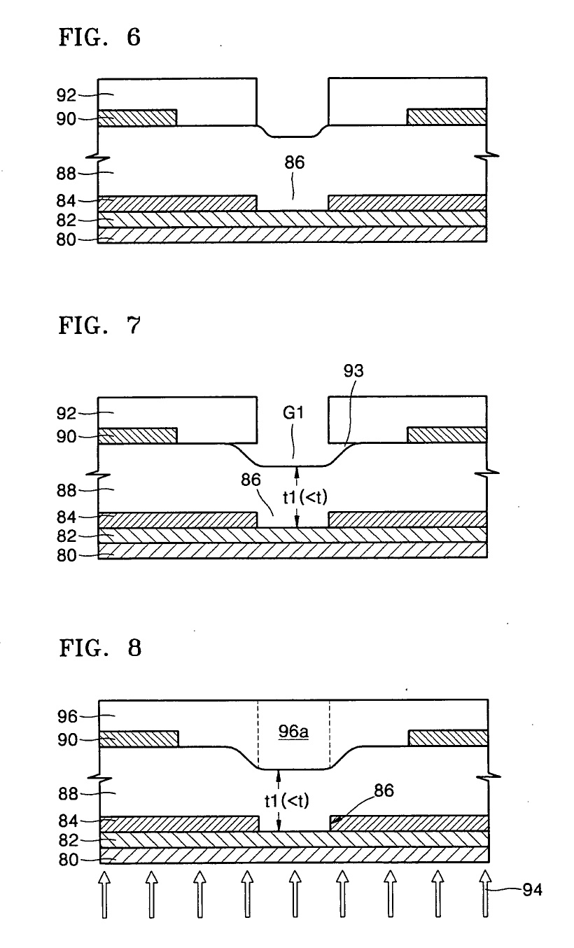

Turning to FIG. 6, the exposed region 92a of the first photosensitive film 92 is removed and then a baking process is performed to harden the remaining patterned photoresist. FIG. 6 shows a resultant product after the developing and the baking processes are sequentially performed. A portion of the insulating film 88 is exposed through a portion from which the exposure region 92a is removed.

Referring to FIG. 7, the insulating film 88 is first etched using the patterned and baked first photosensitive film 92 as an etch mask. The first etching is a wet etching using a predetermined etchant and is performed for a determined period. Thus a first groove G1 with a predetermined depth is formed in the exposed portion of the insulating film 88 by the first etching. The thickness t1 of the insulating film 88 where the first groove region G1 is formed is thinner than the thickness t of other regions of the insulating film 88 that are not etched. The first groove G1 extends under the first photosensitive film 92 due to an isotropic characteristic of the wet etching. Therefore, a first undercut 93 is formed under the first photosensitive film 92. The first photosensitive film 92 is then removed after the first etching.

Referring to FIG. 8, after removing the first photosensitive film 92, a second photosensitive film 96 is formed on the insulating film 88 and on the second electrode 90. The second photosensitive film 96 is formed of the same material as the first photosensitive film 92. A second back exposing is performed after forming of the second photosensitive film 96 where again, layer 84 serves as the photo mask. In the second back exposing process, a region 96a corresponding to the contact hole 86 of the second photosensitive film 96 is exposed.

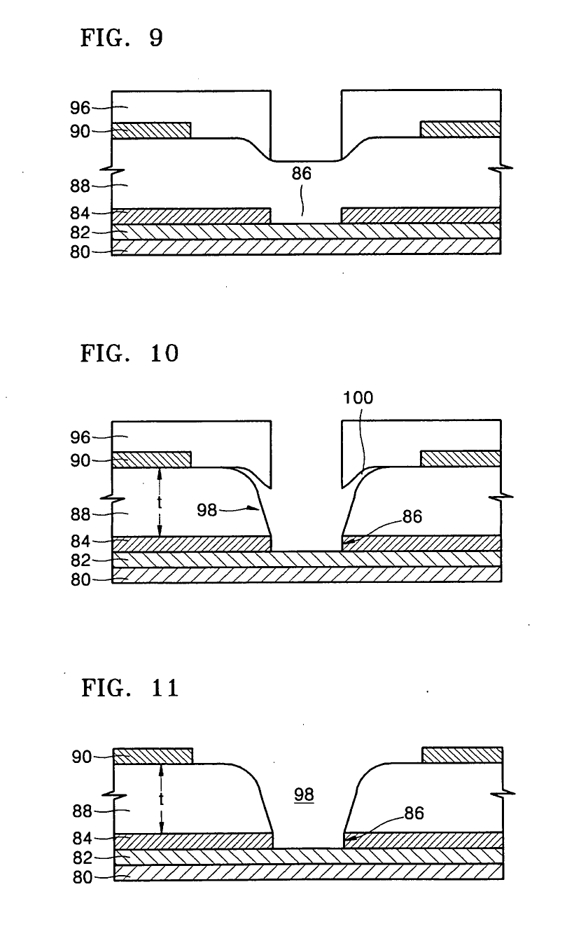

After the back exposure of second photosensitive film 96, the second exposed region 96a is removed by performing a developing process, resulting in the structure as illustrated in FIG. 9. After removing the second exposed region 96a, a bake process is performed. As illustrated in FIG. 9, a portion of the first groove G1 is exposed by the developed second photosensitive film 96.

Turning now to FIG. 10, the insulating film 88 in which the first groove G1 is formed is subjected to a second etch until the insulating film 88 is completely perforated and first electrode 82 is exposed using the second photosensitive film 96 serving as an etch mask. The second etching can be wet etching using a predetermined etchant. That is, a through hole 98 that exposes a portion of the first electrode 82 is formed in the insulating film 88. The through hole 98 extends under the second photosensitive film 96 due to the characteristics of the wet etching. As a result, a second undercut 100 is formed under the second photosensitive film 96.

Turning to FIG. 11, the second photosensitive film 96 is removed by ashing and stripping. Then, processes for cleaning and drying are performed. Thus, a smooth through hole 98 that exposes the first electrode 82 is formed through the insulating film 88.

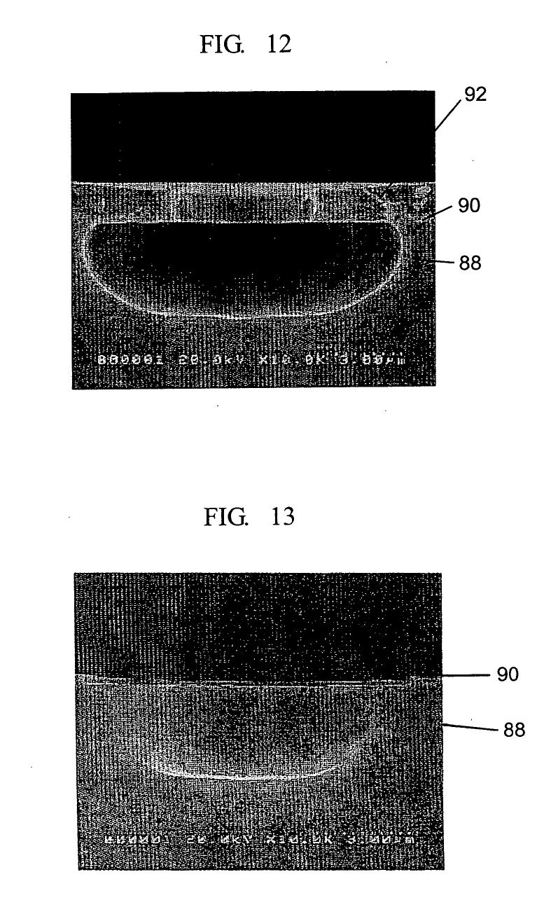

Turning to FIG. 12, FIG. 12 is a SEM image of a resultant product right after the first etching the insulating film, where the first photosensitive film 92, the second electrode 90, and the insulating film 88 are seen as in FIG. 7.

Turning to FIG. 13, FIG. 13 is a SEM image of a resultant product after removing the first photosensitive film 92 in FIG. 12. A slightly recessed portion on the insulating film 88 is a region in which the first photosensitive film 92 was located.

The described insulating film 88 can be wet etched more than twice, and the through hole 98 formed in the insulating film 88 can be formed by wet etching up to four times. The wet etching processes are the same for etching the insulating film both the first and second times.

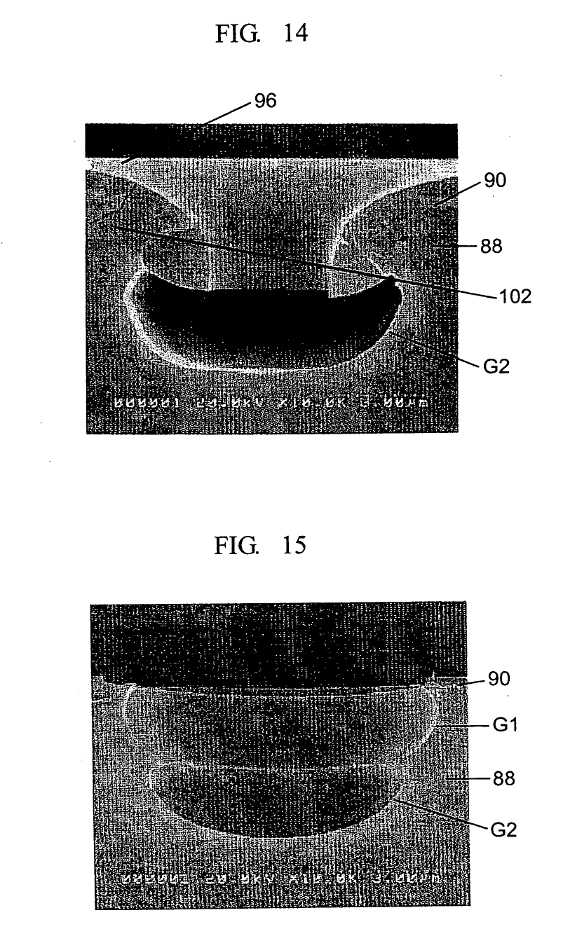

Turning to FIG. 14, FIG. 14 is a SEM image of a resultant product right after the second wet etching when four wet etches are used to perforate the insulating film. Reference numeral 102 represents an interface between the second photosensitive film 96 and the insulating film 88.

FIG. 15 is a SEM image of a resultant product after removing the second photosensitive film 96 in FIG. 14, cleaning, and drying. Referring to FIG. 15, a second groove G2 is formed in a region below the first groove G1. A slightly concaved portion on the first groove G1 is a region at which the second photosensitive film 96 was located.

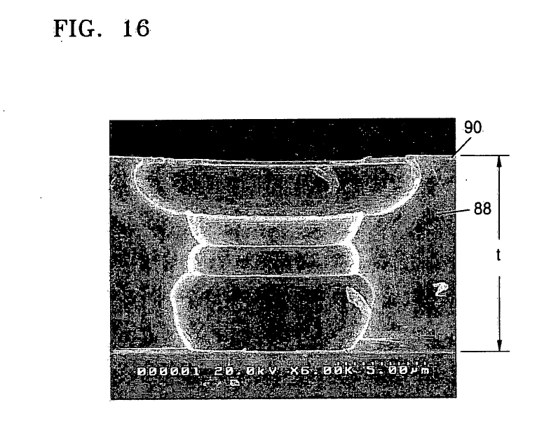

FIG. 16 is a SEM image of a resultant product after fourth wet etching when four wet etches are needed to perforate through insulating film 88. Referring to FIG. 16, a contact hole is vertically formed in the insulating film 88. In general, a vertical profile of the contact hole is well formed. Reference character t represents a thickness of the insulating film 88.

Although the process described in conjunction with FIGS. 3 through 11 can be used to form a perforation through the gate insulating film 36, it is to be understood that a similar process can be used to form focus gate insulating film 40 and the hole therethrough. When forming the gate insulating film 36 and the hole therethrough, reference numeral 90 corresponds to reference numeral 38 in FIG. 2, and reference numeral 88 corresponds to reference numeral 36 in FIG. 2. When forming the focus gate insulating film 40 and the hole therethrough, reference numeral 90 corresponds to reference numeral 42 in FIG. 2 and reference numeral 88 corresponds to reference numeral 40 in FIG. 2.

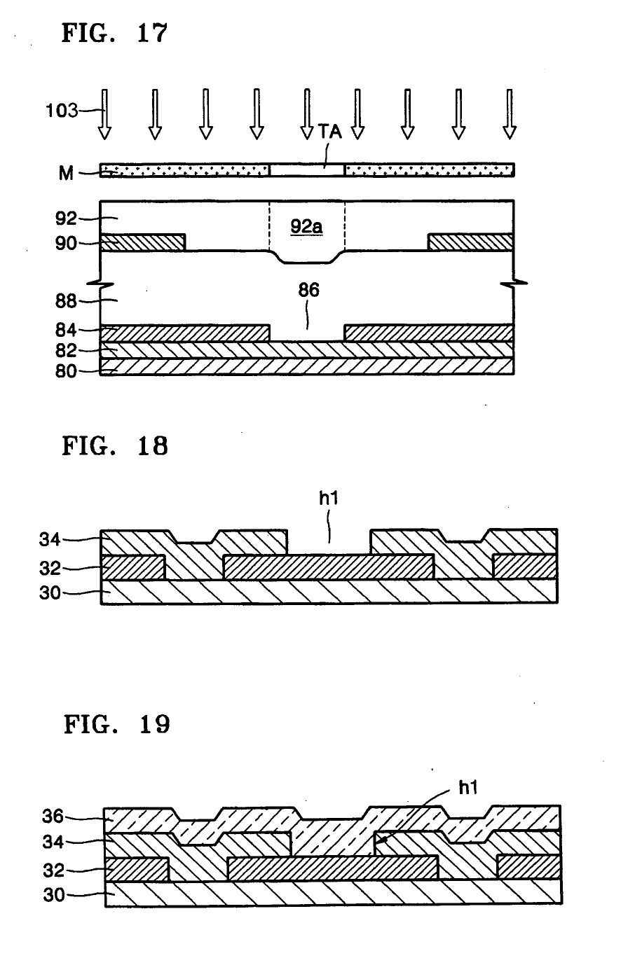

Up until now, the photosensitive layers have been exposed through the substrate via a back side exposure where a layer in the structure serves as the mask. In another embodiment of the present invention, the exposure can be applied at the top of the structure where a separate photomask is used. FIG. 17 illustrates this embodiment where exposure is from a top side.

Referring to FIG. 17, a mask M is placed a predetermined distance above the first photosensitive film 92, the mask M has a transmission window TA in a region corresponding to the contact hole 86 and the rest region of the mask M is a light shielding region. Light 103 is irradiated from above the mask M toward the mask M. A portion of the light 103 irradiated toward the mask M is incident on the first photosensitive film 92 through the transmission window TA. Accordingly, a predetermined region 92a of the first photosensitive film 92 is exposed. Then, the mask M is removed. The first photosensitive film 92 is developed, baked and cleaned. Then, the wet etching process using the first photosensitive film 92 as the etch mask is the same as the above descriptions. The front exposing method according to the present invention can be applied to the exposing processes for patterning the insulating film 88 up to four times. This process of exposing from above can be used to form none, one or both of insulator films 36 and 40 and the contact holes therethrough in the FED of FIG. 2.

Next, a method of manufacturing the CNT FED illustrated in FIG. 2 using the above-described deposition and etching processes performed on the insulating film 88 will now be described. Referring to FIG. 18, a transparent electrode 32 is formed on a glass substrate 30. The transparent electrode 32 may preferably be formed using indium tin oxide, but other materials may instead be used.

A first mask layer 34 for back exposing that covers the transparent electrode 32 is formed on the glass substrate 30. The first mask layer 34 is preferably formed of a material that is transparent to visible light but opaque to ultra violet rays, that is, an amorphous silicon layer doped with predetermined conductive impurities. When the first mask layer 34 is formed of an amorphous silicon layer, the thickness of the first mask layer 34 is controlled to be about 1 μm. The deposition temperature is maintained at 340° C., the flow rate of phosphine (PH₃) used as a doping material and the flow rate of silane (SH₄) used as a source material are maintained at 73 sccm and 1,000 sccm, respectively. The power and pressure levels are maintained at 100 W and 750 mTorr, respectively. A first through hole h1 that exposes a portion of the transparent electrode 32 on which a CNT emitter will be formed is formed in the first mask layer 34.

Turning now to FIG. 19, a gate insulating film 36 that fills the first through hole h1 is formed on the first mask layer 34. The gate insulating film 36 is formed of a silicon oxide film (SiO₂) to a thickness of 1˜5 μm. The gate insulating film 36 can be formed of a silicon rich silicon oxide film (SiO_{X}, X<2) instead of a general silicon oxide film. In this case, the gate insulating film 36 can be formed by the method of forming the insulating film 88 depicted in FIGS. 3 through 11. It is desirable to use the back exposing as an exposing process, but the front exposing as depicted in FIG. 17 can also be used.

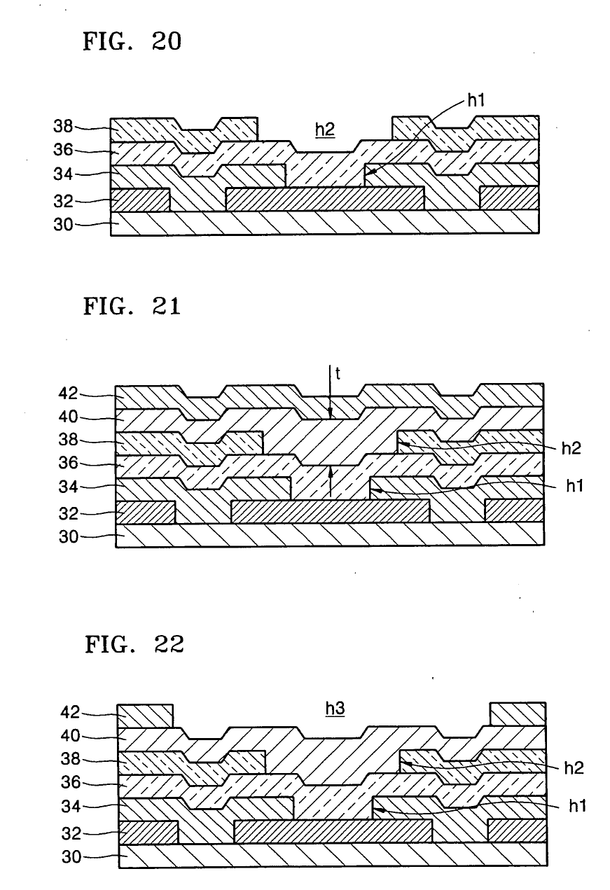

Referring to FIG. 20, a gate electrode 38 is formed on the gate insulating film 36. The gate electrode 38 is formed of a chrome electrode with a thickness of about 0.25 μm. A second through hole h2 is then formed in the gate electrode 38 by patterning the gate electrode 38. At least a portion of the gate insulating film 36 that fills the first through hole h1 is exposed through the second through hole h2. The diameter of the first through hole h1 is smaller than the diameter of the second through hole h2.

Referring to FIG. 21, a focus gate insulating film 40 that fills the second through hole h2 is formed on the gate electrode 38. The focus gate insulating film 40 can be formed using the same method as that used to form the insulating film 88 depicted in FIG. 3 through 11. It is desirable to use the back exposing as an exposing process, but the front exposing as depicted in FIG. 17 can also be used.

Referring to graph 70 in FIG. 33 showing a leakage current characteristics of the focus gate insulating film 40 according to a thickness, it is seen that the leakage current is drastically reduced as the thickness of the focus gate insulating film 40 approaches 6 μm. Above 6 μm, the leakage current is almost zero. Therefore, the thickness of the focus gate insulating film 40 can be at least 2 μm, preferably 3˜15 μm, and more preferably 6˜15 μm.

Referring to FIG. 21, a focus gate electrode 42 is formed on the focus gate insulating film 40. The focus gate electrode 42 is a second chrome electrode. As shown in FIG. 22, a third through hole h3 is formed in the focus gate electrode 42. The focus gate insulating film 40 that covers the second through hole h2 and a portion of the gate electrode 38 around the second through hole h2 is exposed through the third through hole h3. The diameter of the third hole h3 is larger than that of the second through hole h2.

The focus gate electrode 42 and the gate electrode 38 can be formed in various types according to a design layout. For example, a plurality of second holes h2 can be formed within a third hole h3 formed in the focus gate electrode 42, or one second through hole h2 can be formed within one third through hole h3.

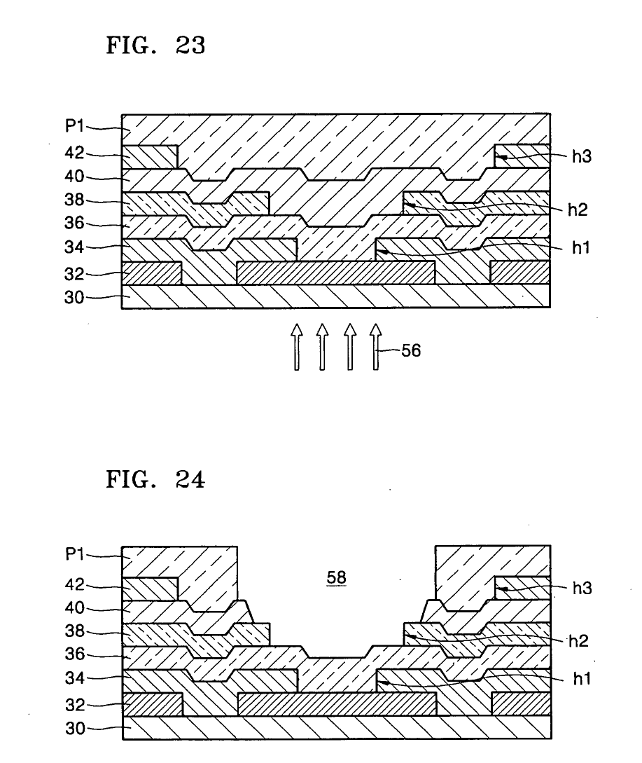

Referring to FIG. 23, a third photosensitive film P1 that fills the third through hole h3 is coated on the focus gate electrode 42. Then, a back exposing process is performed. That is, ultra violet rays 56 are irradiated onto the bottom of the glass substrate 30. The ultra violet rays 56 are incident to the third photosensitive film P1 through the transparent electrode 32, the first through hole h1, the gate insulating film 36, and the focus gate insulating film 40. The ultra violet light 56 incident to regions other than first through hole h1 are blocked by the first mask layer 34. Accordingly, only the region above the first through hole h1 in the third photosensitive film P1 is exposed by the ultra violet light 56. The exposed region of the third photosensitive film P1 is removed by a developing process, thus exposing a portion of the focus gate insulating film 40. The exposed portion of the focus gate insulating film 40 is etched by wet etching using the third photosensitive film P1 as an etch mask. The wet etching is performed until the gate insulating film 36 is exposed, and it is desirable to perform the wet etching according to the etching process depicted in FIGS. 6 through 11. At this time, the wet etching can be sequentially performed two or more times.

Turning to FIG. 24, FIG. 24 illustrates a resultant product after removing the exposed portion defined by the third photosensitive film P1 of the focus gate insulating film 40 using the wet etching. Referring to FIG. 24, a groove 58 is formed in the removed region of the exposed portion of the focus gate insulating film 40.

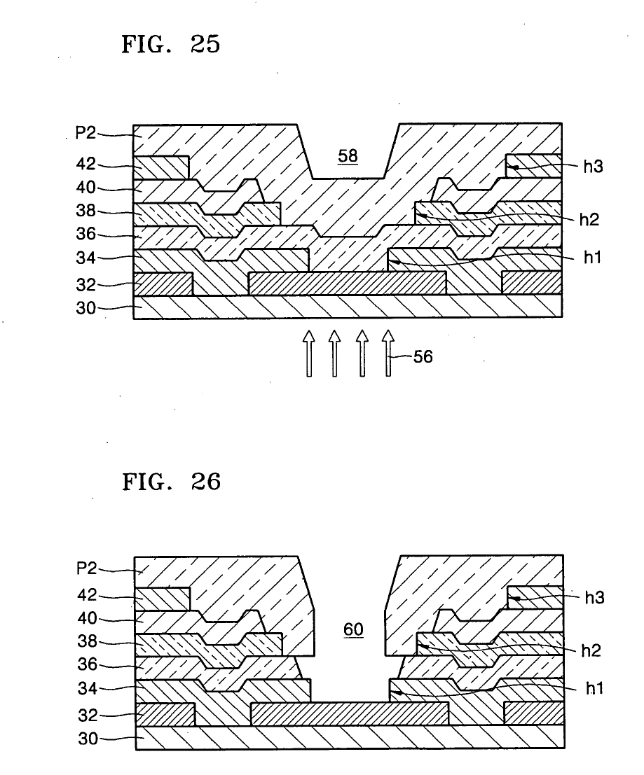

Turning to FIGS. 25 and 26, FIGS. 25 and 26 illustrate processes of partially removing the gate insulating film 36 exposed through the groove 58 after forming a fourth photosensitive film P2. This process is the same process as that used to remove the focus gate insulating film 40 illustrated in FIGS. 23 and 24.

Referring to FIG. 26, a hole 60 through which at least the transparent electrode 32 is exposed is formed in the gate stack that is made up of the second mask layer 34, the gate insulating film 36, the gate electrode 38, the focus gate insulating film 40, and the focus gate electrode 42 by removing the exposed portion of the gate insulating film 36. The hole 60 corresponds to the contact hole 44 depicted in FIG. 2. Afterward, the fourth photosensitive film P2 used for wet etching the exposed portion of the gate insulating film 36 is removed.

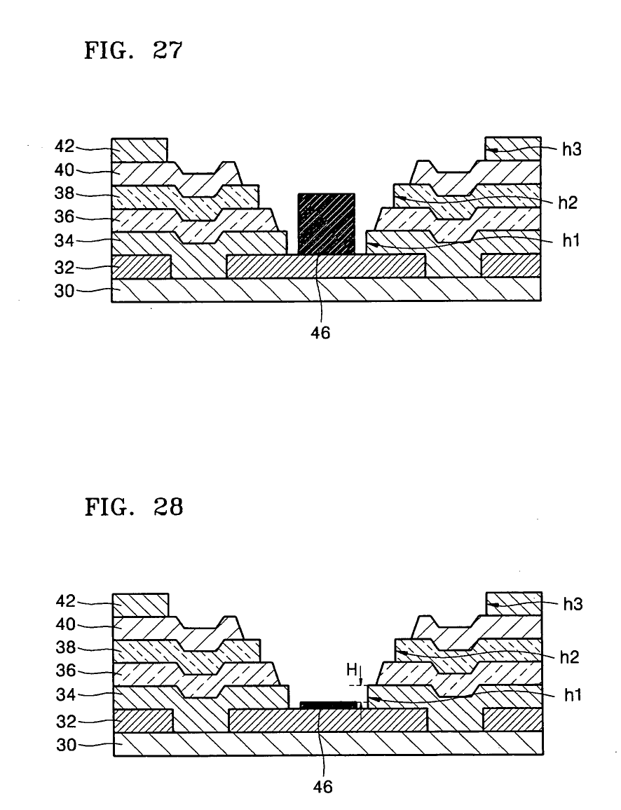

After removing the fourth photosensitive film P2, as shown in FIG. 27, a CNT emitter 46 is formed on a portion of the transparent electrode 32 exposed through the hole 60 using a screen printing method. It is desirable that the CNT emitter 46 is formed in the center of the exposed portion of the transparent electrode 32 and formed not to contact the gate stack around the CNT emitter 46.

After the formation of the CNT emitter 46, the height of the CNT emitter 46 is reduced to be lower than that of the first mask layer 34. The height of the CNT emitter 46 is reduced by surface treatment until the height difference (H) between the first mask layer 34 and the CNT emitter 46 reaches preferably, 0.1-4 μm. By reducing the height of the CNT emitter 46 to this level, focusing of electrons emitted from the CNT emitter 46 can be increased even when the focus gate electrode 42 has a smaller thickness.

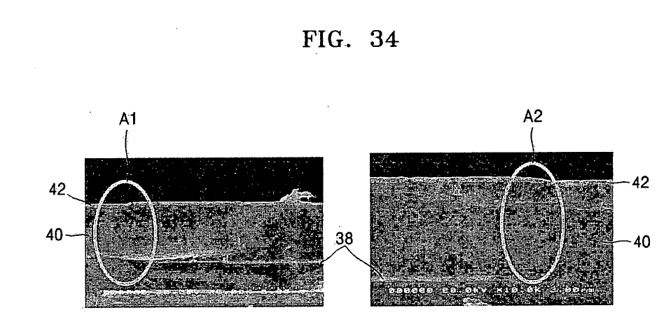

Turning now to FIG. 34, FIG. 34 illustrates an SEM picture of the FED of FIG. 2 manufactured according to the present invention. As illustrated in FIG. 34, FIG. 34 shows different portions of the gate electrode 38, the focus gate insulating film 40, and the focus gate electrode 42 of the CNT FED illustrated in FIG. 2.

Referring to FIG. 34, reference character A1 represents a first step between the gate electrode 38 and the focus gate electrode 42, and A2 represents a second step, and it is seen that step coverages of the first and the second steps A1 and A2 are excellent. Also, no defects that can cause a leakage current are observed in the first and second steps A1 and A2.

As described above, the CNT FED according to the exemplary embodiment of the present invention includes a focus gate insulating film 40 with a thickness of at least 2 μm between a focus gate electrode 42 and a gate electrode 38. The focus gate insulating film 40 has superior step coverage for a step portion, and does not generate defects such as cracks that can cause a leakage current. Also, since the focus gate insulating film 40 is thick, a gap between the focus gate electrode 42 and the gate electrode 38, which is measured along the inner walls of a hole formed in the gate stack, is increased. Accordingly, leakage current between the focus gate electrode 42 and the gate electrode 38 caused by impurities adhered to side walls of the focus gate insulating film 40 during a manufacturing process is reduced. As a result, overall leakage current between the focus gate electrode 42 and the gate electrode 38 is significantly reduced. Since the height of the CNT emitter 46 is smaller than the height of the surrounding mask layer 34, the focusing of electrons emitted from the CNT emitter 46 is increased.

In the method of manufacturing the CNT FED according to the present invention, after forming a mask layer 34 that defines a transparent electrode region for forming a CNT emitter 46 between the transparent electrode 32 and the gate insulating film 36, a photosensitive film coated on the region for forming the CNT emitter 46 is patterned by irradiating ultra violet rays from below the transparent electrode 32. An additional mask that defines the exposure region is unnecessary because the exposure region is already defined by the mask layer 34. That is, the exposure region is self-aligned by the mask layer 34, thus simplifying the manufacturing process and reducing costs. No separate mask is required for an exposing process, so that the manufacturing cost for making the CNT FED is further reduced.

Although in the method of manufacturing the CNT FED according to the present invention described above, the focus gate insulating layer 40 is formed of a silicon oxide film in the embodiments disclosed herein, the focus gate insulating layer 40 can instead be formed of any other appropriate insulating film having a sufficient thickness. Furthermore, the focus gate electrode 42 can also be formed asymmetrically with respect to the CNT emitter 46.

While the present invention has been particularly shown and described with reference to exemplary embodiments thereof, it will be understood by those of ordinary skilled in the art that various changes in form and details may be made therein without departing from the spirit and scope of the present invention as defined by the following claims.

What is claimed is:

1. A carbon nanotube field emission display (CNT FED), comprising:
a substrate;
a transparent electrode arranged on the substrate;
a carbon nanotube (CNT) emitter arranged on the transparent electrode;
a gate stack arranged around a periphery of the CNT emitter, the gate stack adapted to extract an electron beam from the CNT emitter and focus the extracted electron beam to a predetermined target;
a front panel arranged above the gate stack and adapted to display information; and
a fluorescent film arranged on a back surface of the front panel, the gate stack comprises a mask layer arranged on the transparent electrode and around the CNT emitter, the mask layer having a height greater than the CNT emitter.

2. The CNT FED of claim 1, the mask layer comprising amorphous silicon doped with conductive impurities.

3. The CNT FED of claim 1, the height of the mask layer being greater than the height of the CNT emitter by 0.1-4.0 μm.

4. The CNT FED of claim 1, the mask layer having a specific resistance of 10²-10⁹ Ωcm.

5. The CNT FED of claim 1, the gate stack further comprises a gate insulating film, a gate electrode, a silicon oxide (SiO_{X}) film where X<2, and a focus gate electrode sequentially arranged on the mask layer.

6. The CNT FED of claim 5, the gate insulating film comprising a silicon oxide (SiO_{X}) film where X<2 and having a thickness of 1-5 μm.

7. The CNT FED of claim 5, the silicon oxide film has a thickness of 3˜15 μm.

8. The CNT FED of claim 5, a plurality of CNT emitters being arranged in one focus gate electrode.

9. A method of manufacturing a carbon nanotube field emission display (CNT FED), comprising:
forming a transparent electrode on a substrate;
forming a CNT emitter on the transparent electrode;
forming a gate stack comprising a mask layer on an area peripheral to the CNT emitter, the mask layer being arranged on the transparent electrode, a height of the CNT emitter being less than a height of the mask layer, the gate stack being adapted to extract an electron beam from the CNT emitter and to focus the extracted electron beam to a predetermined target;
forming a front panel above the gate stack, the front panel being adapted to display information; and
forming a fluorescent film on a back surface of the front panel.

10. The method of claim 9, the mask layer being formed with a through hole that exposes a portion of the transparent electrode, the forming the gate stack comprises:
forming a gate insulating film that fills the through hole in the mask layer;
forming a gate electrode on the gate insulating film and around the through hole;
forming a focus gate insulating film (SiOₓ, x<2) on the gate electrode and the gate insulating film;
forming a focus gate electrode on the focus gate insulating film and around the through hole; and
removing a portion of the gate insulating film and a portion of the focus gate insulating film arranged above the through hole.

11. The method of claim 10, wherein the gate insulating film is formed of one of a silicon oxide (SiO₂) film and a another silicon oxide (SiO_{X}) film where X<2.

12. The method of claim 10, wherein the focus gate insulating film is formed to a thickness of 3˜15 μm.

13. The method of claim 11, wherein the another silicon oxide film is formed to a thickness of 1˜5 μm.

14. The method of claim 10, wherein in the forming the focus gate insulating film, a flow rate of silane (SiH₄) is maintained at 50˜700 sccm.

15. The method of claim 10, wherein in the forming the focus gate insulating film, a flow rate of nitric acid (N₂O) is maintained at 700˜4,500 sccm.

16. The method of claim 10, wherein in the forming the focus gate insulating film, a process pressure is maintained at 600˜1,200 mTorr.

17. The method of claim 10, wherein in the forming the focus gate insulating film, a temperature of the substrate is maintained at 250˜450° C.

18. The method of claim 10, wherein in the forming the focus gate insulating film, an RF power is maintained at 100˜300 W.

19. The method of claim 11, wherein in the forming the another silicon oxide film, a flow rate of silane (SiH₄) is maintained at 50˜700 sccm.

20. The method of claim 11, wherein in the forming the another silicon oxide layer, a flow rate of nitric acid (N₂O) is maintained at 700˜4,500 sccm.

21. The method of claim 10, wherein the removing of the focus gate insulating film comprises:
coating a photosensitive film on the focus gate electrode and on the focus gate insulating film arranged within the focus gate electrode;
exposing a portion of the photosensitive film arranged above the through hole;
removing the exposed portion of the photosensitive film;
wet etching the focus gate insulating film using the photosensitive film from which the exposed portion is removed as an etch mask; and
removing the photosensitive film.

22. The method of claim 21, wherein all the processes involved in the removing the focus gate insulating layer are repeated.

23. The method of claim 21, wherein the photosensitive film is exposed to ultra violet rays from below the substrate during the exposing a portion of the photosensitive film.

24. The method of claim 21, wherein the exposing a portion of the photosensitive film comprises:
arranging a mask having a transmission window to a region corresponding to the through hole over the photosensitive film; and
radiating light toward the mask from above the mask.

25. The method of claim 10, wherein the removing of the gate insulating film comprises:
coating a photosensitive film on a resultant product from which the focus gate insulating film is removed, inside of the gate electrode;
exposing a portion of the photosensitive film arranged over the through hole;
removing the exposed portion of the photosensitive film;
wet etching the gate insulating film using the photosensitive film from which the exposed portion is removed as an etch mask; and
removing the photosensitive film.

26. The method of claim 21, wherein all the processes involved in the removing the gate insulating film are repeated until etched entirely through.

27. The method of claim 25, wherein the photosensitive film is exposed to ultra violet rays from below the substrate during the exposing a portion of the photosensitive film.

28. The method of claim 25, wherein exposing the photosensitive film comprises:
arranging a mask having a transmission window to a region corresponding to the through hole over the photosensitive film; and
radiating light toward the mask from above the mask.

29. The method of claim 10, wherein the focus gate electrode is formed such that a plurality of through holes are formed in the focus gate electrode.

30. The method of claim 9, wherein the forming the CNT emitter having a height smaller than the mask layer comprises:
forming a CNT emitter having a height greater than the mask layer; and
reducing the height of the CNT emitter by surface treatment to be lower than the mask layer.

31. The method of claim 9, wherein the height of the CNT emitter is reduced until a height difference between the mask layer and the CNT emitter reaches a range of 0.1-4 μm.

32. The method of claim 9, wherein the mask layer comprises a material layer having a specific resistance of 10²-10⁹ Ωcm.

33. The method of claim 9, wherein the mask layer is made of an amorphous silicon layer doped with predetermined conductive impurities.
